(19) United States
(12) Patent Application Publication
(10) Pub. No.: US 2023/0013945 A1
(43) Pub. Date: Jan. 19, 2023

(54) SOLENOID VALVE

(71) Applicant: DENSO CORPORATION, Kariya-city (JP)

(72) Inventor: Kazuhiro SASAO, Kariya-city (JP)

(21) Appl. No.: 17/948,962

(22) Filed: Sep. 20, 2022

Related U.S. Application Data
(63) Continuation of application No. PCT/JP2021/011101, filed on Mar. 18, 2021.

(30) Foreign Application Priority Data
Mar. 23, 2020 (JP) 2020-050437

(51) Int. Cl. F16K 31/06

(52) U.S. Cl. CPC F16K 31/0675; F16K 31/0613

(57) ABSTRACT

A valve portion of a solenoid valve has a sleeve and a spool. The sleeve has a housing portion larger than an insertion hole in a radial direction. An elastic member is arranged in the housing portion to urge a stator core toward a bottom of a yoke. The elastic member is in contact with a surface of the housing portion, which is non-contact with the spool, facing toward a solenoid portion. The elastic member is in contact with an end surface of a magnetic attraction core adjacent to the valve portion.

### CROSS REFERENCE TO RELATED APPLICATIONS

The present application is a continuation application of International Patent Application No. PCT/JP2021/011101 filed on Mar. 18, 2021, which designated the U.S. and claims the benefit of priority from Japanese Patent Application No. 2020-050437 filed on Mar. 23, 2020. The entire disclosures of all of the above applications are incorporated herein by reference.

### TECHNICAL FIELD

The present disclosure relates to a solenoid valve.

### BACKGROUND

A solenoid valve has a solenoid portion and a valve portion. The solenoid portion has a plunger configured to slide in a stator core, inside a coil that generates a magnetic force. The valve portion has a sleeve in which a spool is arranged.

### SUMMARY

A solenoid valve includes: a solenoid portion having a coil that generates a magnetic force when being energized; and a valve portion having a sleeve extending in an axial direction, the sleeve having an insertion hole formed along a central axis and a housing portion formed by radially expanding an end portion of the insertion hole adjacent to the solenoid portion. The valve portion has a spool arranged in the insertion hole to slide in the axial direction. The spool has a spool end portion that is an end portion of the spool adjacent to the solenoid portion. The spool end portion is located in the housing portion when a movement of the spool is restricted toward the solenoid portion. An outer diameter of the spool end portion in a radial direction orthogonal to the axial direction is monotonically increased from the solenoid portion toward the valve portion. The solenoid portion has a magnetic yoke housing the coil, the magnetic yoke having a side wall extended in the axial direction and a bottom formed to extend in a direction intersecting the axial direction. The solenoid portion has a plunger that slides in the axial direction. The solenoid portion has a stator core including a magnetic attraction core arranged to face a distal end surface of the plunger in the axial direction and configured to attract magnetically the plunger by the magnetic force generated by the coil. The stator core has a sliding core including: a core portion arranged inside the coil in the radial direction and housing the plunger; and a first magnetic flux transfer portion formed radially outward from a core end which is an end portion of the core portion in the axial direction and faces the bottom so as to transfer magnetic flux between the yoke and the core portion. The stator core has a magnetic flux passage suppresser configured to suppress passage of magnetic flux between the sliding core and the magnetic attraction core. The solenoid portion has a shaft provided between the plunger and the spool in the axial direction. The shaft is arranged inside the magnetic attraction core in the radial direction so as to transmit a thrust of the solenoid portion to the spool. An elastic member is arranged in the housing portion to urge the stator core toward the bottom at a radially outer side of an outer peripheral surface of the spool end portion. The elastic member is in contact with a surface of the housing portion which is non-contact with the spool when the spool slides toward the solenoid portion, and is in contact with an end surface of the magnetic attraction core adjacent to the valve portion.

### BRIEF DESCRIPTION OF DRAWINGS

FIG. 1 is a schematic cross-sectional view showing a solenoid valve according to a first embodiment.

FIG. 2 is a diagram for explaining a magnetic flow in the solenoid valve.

FIG. 3 is a schematic cross-sectional view showing a solenoid valve according to a second embodiment.

FIG. 4 is a schematic cross-sectional view showing a solenoid valve according to a third embodiment.

### DETAILED DESCRIPTION

To begin with, examples of relevant techniques will be described.

A solenoid valve has a solenoid portion and a valve portion. In the solenoid portion, a plunger slides inside a stator core in a coil that generates a magnetic force by energization. The valve portion has a sleeve into which a spool is inserted.

The inventor provides a solenoid valve having an elastic member located on a radially outer side of a spool in a sleeve adjacent to a solenoid portion where a diameter of a spool insertion hole is increased. The elastic member biases a stator core toward a bottom of a yoke. However, in this structure, if the outer peripheral surface of the spool comes into contact with the elastic member, the sliding of the spool is hindered, so that it may be difficult to increase the outer diameter of the spool. Therefore, in the solenoid valve, there is a need for increasing the outer diameter of the spool while the elastic member is in contact with the stator core to urge the stator core toward the bottom of the yoke.

The present disclosure can be realized as the following aspect.

According to an aspect of the present disclosure, a solenoid valve includes: a solenoid portion having a coil that generates a magnetic force when being energized; and a valve portion having a sleeve extending in an axial direction, the sleeve having an insertion hole formed along a central axis and a housing portion formed by radially expanding an end portion of the insertion hole adjacent to the solenoid portion. The valve portion has a spool arranged in the insertion hole to slide in the axial direction. The spool has a spool end portion that is an end portion of the spool adjacent to the solenoid portion. The spool end portion is located in the housing portion when a movement of the spool is restricted toward the solenoid portion. An outer diameter of the spool end portion in a radial direction orthogonal to the axial direction is monotonically increased from the solenoid portion toward the valve portion. The solenoid portion has a magnetic yoke housing the coil, the magnetic yoke having a side wall extended in the axial direction and a bottom formed to extend in a direction intersecting the axial direction. The solenoid portion has a plunger that slides in the axial direction. The solenoid portion has a stator core including a magnetic attraction core arranged to face a distal end surface of the plunger in the axial direction and configured to attract magnetically the plunger by the magnetic force generated by the coil. The stator core has a sliding core including: a core portion arranged inside the coil in the radial direction and housing the plunger; and a first magnetic flux transfer portion formed radially outward from a core end which is an end portion of the core portion in the axial direction and faces the bottom so as to transfer magnetic flux between the yoke and the core portion. The stator core has a magnetic flux passage suppresser configured to suppress passage of magnetic flux between the sliding core and the magnetic attraction core. The solenoid portion has a shaft provided between the plunger and the spool in the axial direction. The shaft is arranged inside the magnetic attraction core in the radial direction so as to transmit a thrust of the solenoid portion to the spool. An elastic member is arranged in the housing portion to urge the stator core toward the bottom at a radially outer side of an outer peripheral surface of the spool end portion. The elastic member is in contact with a surface of the housing portion which is non-contact with the spool when the spool slides toward the solenoid portion, and is in contact with an end surface of the magnetic attraction core adjacent to the valve portion.

Accordingly, the outer diameter of the spool end portion located in the housing portion of the sleeve monotonically increases from the solenoid portion toward the valve portion in the axial direction. The elastic member is provided in the housing portion and is arranged on the radially outer side of the outer peripheral surface of the spool end portion. The elastic member is in contact with a surface of the housing portion which is non-contact with the spool when the spool slides toward the solenoid portion. The elastic member is in contact with an end surface of the magnetic attraction core adjacent to the valve portion. Therefore, the outer diameter of the spool can be increased, while the spool can slide without being hindered by the elastic member and the elastic member is brought into contact with the end surface of the stator core to urge the stator core toward the bottom of the yoke.

The present disclosure can be realized as the following embodiments. For example, the present disclosure can be realized in an automatic transmission for a vehicle using a solenoid valve.

### First Embodiment

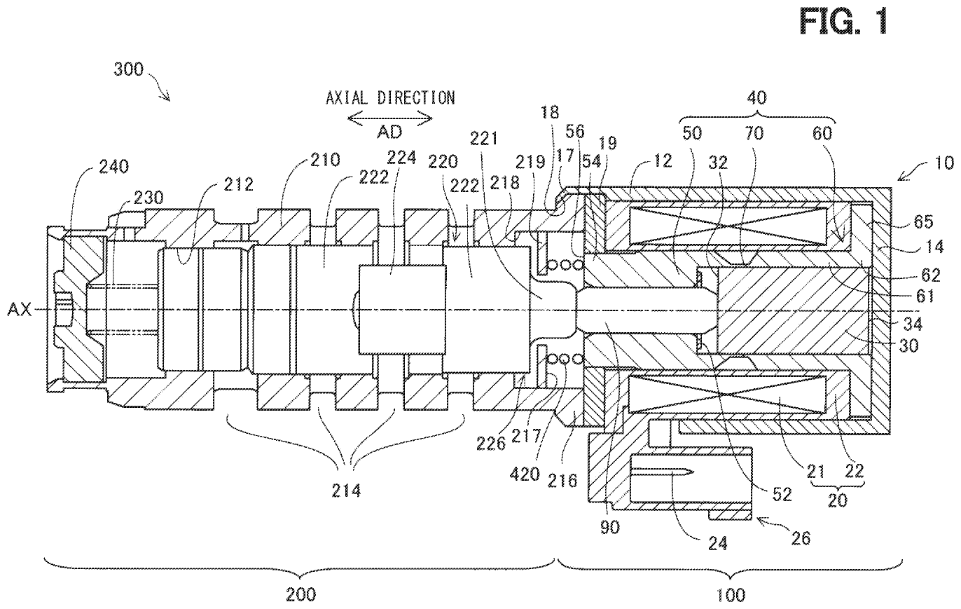

A solenoid valve 300 of a first embodiment shown in FIG. 1 is a linear solenoid valve, which is used to control the hydraulic pressure of hydraulic oil supplied to an automatic transmission for vehicles (not shown), and is mounted on a valve body provided on an outer surface of a transmission case (not shown). FIG. 1 schematically shows a cross section of the solenoid valve 300 taken along a central axis AX. The solenoid valve 300 includes a solenoid portion 100 and a valve portion 200 arranged side by side along a central axis AX. In addition, in FIG. 1 and the following figures, the solenoid valve 300 in the non-energized state is shown. The axial direction AD shown in FIG. 1 is a direction parallel to the central axis AX of the sleeve 210 included in the solenoid valve 300. The solenoid valve 300 of the present embodiment is a normally closed type, but may be a normally open type.

The valve portion 200 shown in FIG. 1 includes a cylindrical sleeve 210, a spool 220, a spring 230, and a spring load adjuster 240. The valve portion 200 is also referred to as a spool valve.

The sleeve 210 has a substantially cylindrical shape extending along the axial direction AD. The sleeve 210 has an insertion hole 212 penetrating along the central axis AX and plural ports 214 communicating with the insertion hole 212 and open in a radial direction perpendicular to the axial direction AD to allow fluid to flow. The spool 220 is inserted into the insertion hole 212. An end of the insertion hole 212 adjacent to the solenoid portion 100 has an enlarged inner diameter and functions as a housing portion 218. A spool end portion 226, which is an end portion of the spool 220 adjacent to the solenoid portion 100, is located in the housing portion 218 when the movement of the spool 220 toward the solenoid portion 100 is restricted. Further, an elastic member 420, which will be described later, is housed in the housing portion 218. The plural ports 214 are formed side by side along the axial direction AD. The plural ports 214 function as, for example, an input port, an output port, a feedback port, a drain port, and the like. The input port communicates with an oil pump (not shown) to receive a hydraulic pressure. The output port communicates with a clutch piston (not shown) to supply a hydraulic pressure. The feedback port applies a load to the spool 220 based on the output hydraulic pressure. The drain port discharges the hydraulic oil. A flange 216 is formed at the end of the sleeve 210 adjacent to the solenoid portion 100. The flange 216 extends outward in the radial direction, and is fixed on the yoke 10.

The spool 220 has a substantially rod-like external shape. The spool 220 has large diameter portions 222 and a small diameter portion 224 arranged side by side in the axial direction AD. As shown in FIG. 1, the spool end portion 226 has the large diameter portion 222 and the small diameter portion 221 having an outer diameter smaller than that of the large diameter portion 222. The small diameter portion 221 of the spool end portion 226 is also referred to as a “first outer diameter portion 221”, and the large diameter portion 222 of the spool end portion 226 is also referred to as a “second outer diameter portion 222”. The second outer diameter portion 222 is connected to the first outer diameter portion 221 and is located between the valve portion 200 and the first outer diameter portion 221 in the axial direction AD. It can be said that the outer diameter of the spool end portion 226 monotonically increases from the solenoid portion 100 toward the valve portion 200 in the axial direction AD. The monotonous increase in the present embodiment means a monotonous increase in a broad sense. The spool end portion 226 has an area where the outer diameter is constant from the solenoid portion 100 toward the valve portion 200. That is, the monotonous increase represents (i) an aspect in which the outer diameter is larger as the position in the axial direction AD is closer to the valve portion 200, and (ii) an aspect in which an outer diameter at a position closer to the valve portion 200 than a predetermined position in the axial direction is larger than an outer diameter at a position closer to the solenoid portion 100 than the predetermined position in the axial direction. As shown in FIG. 1, the outer diameter of the second outer diameter portion 222 is larger than the outer diameter of the end portion 54 of the magnetic attraction core 50 adjacent to the valve portion 200. More specifically, the outer diameter of the second outer diameter portion 222 is larger than the outer diameter of a portion of the magnetic attraction core 50 corresponding to the end surface 56 adjacent to the valve portion 200. Further, the outer diameter of the first outer diameter portion 221 is smaller than the outer diameter of the end portion 54 of the magnetic attraction core 50. More specifically, the outer diameter of the first outer diameter portion 221 is smaller than the outer diameter of a portion of the magnetic attraction core 50 corresponding to the end surface 56 adjacent to the valve portion 200. As described above, the second outer diameter portion 222 (large diameter portion 222) of the spool 220 is formed to have a larger diameter than the outer diameter of the end portion 54 of the magnetic attraction core 50.

The spool 220 slides along the axial direction AD inside the insertion hole 212, and adjusts the opening areas of the ports 214 according to a position between the large diameter portion 222 and the small diameter portion 224 in the axial direction AD. The shaft 90 is in contact with the spool end portion 226 of the spool 220 adjacent to the solenoid portion 100 so as to transmit a thrust of the solenoid portion 100 to the spool 220. The spring 230 is arranged at the other end of the spool 220 opposite to the spool end portion 226 in the axial direction AD. The spring 230 is configured by a compression coil spring, and presses the spool 220 in the axial direction AD to urge the spool 220 toward the solenoid portion 100. The spring load adjuster 240 is arranged to be in contact with the spring 230, and adjusts the spring load of the spring 230 by adjusting an amount of screwing into the sleeve 210.

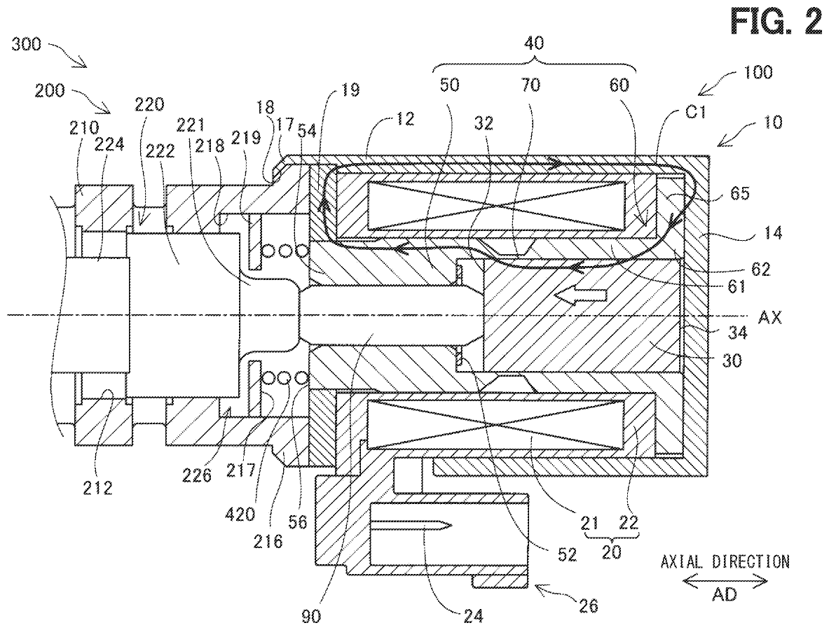

The solenoid portion 100 shown in FIGS. 1 and 2 is energized and controlled by an electronic control device (not shown) to drive the valve portion 200. The solenoid portion 100 includes the yoke 10, the coil portion 20, the plunger 30, the shaft 90, the stator core 40, and the elastic member 420. The solenoid portion 100 further includes a ring member 19.

The yoke 10 is made of a magnetic metal, and forms an outer shell of the solenoid portion 100. The yoke 10 has a bottomed cylindrical external shape, and houses the coil portion 20, the plunger 30, the stator core 40 and the ring member 19. The yoke 10 has a side wall 12, a bottom 14, a thin wall portion 17, and an opening part 18.

The side wall 12 has a substantially cylindrical external shape along the axial direction AD, and is disposed radially outside the coil portion 20. The bottom 14 is formed at the end of the side wall 12 opposite to the valve portion 200 and extended perpendicular to the axial direction AD to close the end of the side wall 12. The bottom 14 is not limited to being perpendicular to the axial direction AD, and may be formed substantially perpendicular to the axial direction AD, or may be formed so as to intersect the axial direction AD at an arbitrary angle other than 90 degrees. The bottom 14 faces a base end surface 34 of the plunger 30 described later. The thin wall portion 17 is connected to an end of the side wall 12 adjacent to the valve portion 200 and has a thickness smaller than that of the side wall 12. The thin wall portion 17 has the opening part 18 of the yoke 10. The opening part 18 is caulked and fixed to the flange 216 of the sleeve 210 after the components of the solenoid portion 100 are assembled inside the yoke 10. Instead of caulking, the valve portion 200 and the yoke 10 may be fixed by any method such as welding.

The ring member 19 is arranged between the coil portion 20 and the flange 216 of the valve portion 200 in the axial direction AD. The ring member 19 is arranged radially outside the end portion 54 of the magnetic attraction core 50 of the stator core 40. The ring member 19 has a ring-like external shape and is made of a magnetic metal. The ring member 19 transfers a magnetic flux between the magnetic attraction core 50 of the stator core 40 and the side wall 12 of the yoke 10. The ring member 19 is displaceable in the radial direction. As a result, variations in the dimensions of the stator core 40 during manufacture and imperfect alignment of the stator core 40 during assembly are absorbed. In the present embodiment, the magnetic attraction core 50 is press-fitted into the ring member 19. The magnetic attraction core 50 may be fitted with the ring member 19 with a slight gap in the radial direction, instead of the press-fitting. The ring member 19 is also referred to as a “second magnetic flux transfer portion 19”.

The coil portion 20 has a tubular shape and is arranged inside the side wall 12 of the yoke 10 in the radial direction. The coil portion 20 has a coil 21 and a bobbin 22. The coil 21 is formed of a conducting wire having an insulating coating. The bobbin 22 is made of resin, and the coil 21 is wound around the bobbin 22. The bobbin 22 is connected to a connector 26 arranged on the outer periphery of the yoke 10. A connection terminal 24 is arranged inside the connector 26, and the end of the coil 21 is connected to the connection terminal 24. The connector 26 electrically connects the solenoid portion 100 to the electronic control device via a connection line (not shown). The coil portion 20 generates a magnetic force when energized, and generates a loop magnetic flux passing through the side wall 12 of the yoke 10, the bottom 14 of the yoke 10, the stator core 40, the plunger 30, and the ring member 19 (hereinafter, referred to as “magnetic circuit Cl”). In FIGS. 1 and 2, the coil portion 20 is not energized and a magnetic circuit is not formed. For convenience of explanation, a part of the magnetic circuit Cl formed when the coil portion 20 is energized is schematically indicated by a thick arrow in FIG. 2.

The plunger 30 has a substantially cylindrical external shape and is made of a magnetic metal. The plunger 30 slides in the axial direction AD on an inner peripheral surface of a core portion 61 of the stator core 40 described later. An end surface of the shaft 90 is in contact with the end surface of the plunger 30 adjacent to the valve portion 200 (hereinafter, also referred to as “distal end surface 32”). As shown in FIG. 2, an end surface of the plunger 30 opposite to the distal end surface 32 (hereinafter, also referred to as a “base end surface 34”) faces the bottom 14 of the yoke 10. The plunger 30 has a breathing hole (not shown) that penetrates in the axial direction AD. The breathing hole allows fluid such as hydraulic oil or air located around the base end surface 34 and the distal end surface 32 of the plunger 30 to flow.

The stator core 40 is made of a magnetic metal, and is disposed between the coil portion 20 and the plunger 30. The stator core 40 integrally includes a magnetic attraction core 50, a sliding core 60, and a magnetic flux passage suppresser 70.

The magnetic attraction core 50 is disposed so as to surround the shaft 90 in a circumferential direction. The magnetic attraction core 50 is a part of the stator core 40 adjacent to the valve portion 200, and magnetically attracts the plunger 30 by the magnetic force generated by the coil portion 20. A stopper 52 is disposed on a surface of the magnetic attraction core 50 facing the distal end surface 32 of the plunger 30. The stopper 52 is made of a non-magnetic material, and suppresses a direct contact between the plunger 30 and the magnetic attraction core 50. Further, the stopper 52 facilitates the plunger 30 to be separated from the magnetic attraction core 50 against the magnetic attraction.

The sliding core 60 is a part of the stator core 40 adjacent to the bottom 14, and is disposed radially outside the plunger 30. The sliding core 60 has a core portion 61 and a magnetic flux transfer portion 65.

The core portion 61 has a substantially cylindrical external shape, and is arranged between the coil portion 20 and the plunger 30 in the radial direction. The core portion 61 guides the movement of the plunger 30 in the axial direction AD. As a result, the plunger 30 slides directly in contact with an inner peripheral surface of the core portion 61. A sliding gap (not shown) is defined between the core portion 61 and the plunger 30 for ensuring the slidability of the plunger 30. An end portion of the sliding core 60 opposite to the magnetic attraction core 50 (hereinafter, also referred to as a “core end 62”) is in contact with the bottom 14.

The magnetic flux transfer portion 65 is formed to extend radially outward from the core end 62 over the entire circumference of the core end 62. Therefore, the magnetic flux transfer portion 65 is arranged between the bobbin 22 and the bottom 14 of the yoke 10 in the axial direction AD. The magnetic flux transfer portion 65 transfers magnetic flux between the yoke 10 and the plunger 30 via the core portion 61. The magnetic flux transfer portion 65 of the present embodiment transfers magnetic flux between the bottom 14 of the yoke 10 and the plunger 30. The magnetic flux transfer portion 65 may transfer magnetic flux between the side wall 12 of the yoke 10 and the plunger 30. The magnetic flux transfer portion 65 of the present embodiment is formed integrally with the core portion 61. The magnetic flux transfer portion 65 is also referred to as a “first magnetic flux transfer portion”.

The magnetic flux passage suppresser 70 is formed between the magnetic attraction core 50 and the core portion 61 in the axial direction AD. The magnetic flux passage suppresser 70 suppresses the flow of magnetic flux directly between the core portion 61 and the magnetic attraction core 50. The magnetic flux passage suppresser 70 of the present embodiment is configured such that a thickness of the stator core 40 in the radial direction is formed to be thin, so that the magnetic resistance of the magnetic flux passage suppresser 70 is higher than that of the magnetic attraction core 50 and the core portion 61.

The elastic member 420 is housed in the housing portion 218 and is arranged radially outside the outer peripheral surface of the spool end portion 226. The elastic member 420 is in contact with the surface of the housing portion 218 facing the solenoid portion 100 in the axial direction AD, and the end surface 56 of the magnetic attraction core 50 adjacent to the valve portion 200 in the axial direction AD. The stator core 40 is urged toward the bottom 14 by the elastic member 420. In this embodiment, the housing portion 218 includes a flange 219 protruding inward in the radial direction. The flange 219 is located radially outside the outer peripheral surface of the spool end portion 226. In the present embodiment, the flange 219 is formed by press-fitting a ring plate, which is a substantially ring-shaped plate-shaped member, into the housing portion 218. As shown in FIGS. 1 and 2, the flange 219 is provided on the radially outer side of the first outer diameter portion 221 of the spool end portion 226. Therefore, the flange 219 is not in contact with the spool 220 when the spool 220 slides. The elastic member 420 is arranged in contact with the surface 217 of the flange 219 facing the solenoid portion 100 and the end surface 56 of the magnetic attraction core 50 adjacent to the valve portion 200. In another embodiment, the flange 219 may be integrally molded with the housing portion 218. In this case, the solenoid valve 300 may be a normally open type.

In the present embodiment, the elastic member 420 has an inner diameter substantially constant in the axial direction AD and an outer diameter substantially constant in the axial direction AD. In the present embodiment, the elastic member 420 is composed of a straight compression coil spring. The compression coil spring is made of a wire having a round cross-sectional shape. The elastic member 420 urges the stator core 40 toward the bottom 14 of the yoke 10 in the axial direction AD, so that the magnetic flux transfer portion 65 is pressed against the bottom 14.

In the present embodiment, the ring member 19, the yoke 10, the plunger 30, and the stator core 40 are each made of iron, but not limited to iron and may be composed of any magnetic material such as nickel and cobalt. In the present embodiment, plating is applied on the outer peripheral surface of the plunger 30, such that the hardness of the plunger 30 is increased, and deterioration of slidability can be suppressed. Further, in the present embodiment, the yoke 10 is formed by press molding and the stator core 40 is formed by forging, but each may be formed by any molding method. For example, the yoke 10 may be integrally formed by the side wall 12 and the bottom 14 to fix by caulking, press-fitting, or the like after being formed separately from each other. Further, in the present embodiment, the main material of the sleeve 210 is aluminum (Al). The main material of the sleeve 210 may be made of any material other than aluminum (Al).

As shown in FIG. 2, the magnetic circuit Cl is formed so as to pass through the side wall 12 of the yoke 10, the bottom 14 of the yoke 10, the magnetic flux transfer portion 65 of the stator core 40, the core portion 61 of the stator core 40, the plunger 30, the magnetic attraction core 50 of the stator core 40, and the ring member 19. Therefore, the plunger 30 is attracted toward the magnetic attraction core 50 by energizing the coil portion 20. As a result, the plunger 30 slides on the inner peripheral surface of the core portion 61, in other words, on the inner peripheral surface of the sliding core 60, in the direction represented by the blank arrow along the axial direction AD. In this way, the plunger 30 strokes toward the magnetic attraction core 50 against the urging force of the spring 230 by energizing the coil portion 20. As the current flowing through the coil portion 20 increases, the magnetic flux density of the magnetic circuit increases, and the stroke amount of the plunger 30 increases. The “stroke amount of the plunger 30” means an amount of the plunger 30 moving toward the magnetic attraction core 50 along the axial direction AD in the reciprocating movement of the plunger 30 from a start position where the plunger 30 is farthest from the magnetic attraction core 50. The state in which the plunger 30 is farthest from the magnetic attraction core 50 corresponds to the non-energized state. The state in which the plunger 30 is farthest from the magnetic attraction core 50 is also a state in which the movement of the spool 220 toward the solenoid portion 100 is restricted. On the other hand, unlike FIG. 2, the plunger 30 is closest to the magnetic attraction core 50, when the coil portion 20 is energized. The distal end surface 32 of the plunger 30 and the stopper 52 are in contact with each other. The stroke amount of the plunger 30 is maximized at this time.

When the plunger 30 moves toward the magnetic attraction core 50, the shaft 90 abutting on the distal end surface 32 of the plunger 30 presses the spool 220 shown in FIG. 1 toward the spring 230. As a result, the opening area of the port 214 is adjusted, and a hydraulic pressure proportional to the value of the current flowing through the coil 21 is output.

According to this embodiment, the outer diameter of the spool end portion 226 located in the housing portion 218 of the sleeve 210 monotonically increases from the solenoid portion 100 toward the valve portion 200 in the axial direction AD. The elastic member 420 is provided in the housing portion 218, and is arranged on the radially outer side of the outer peripheral surface of the spool end portion 226. The elastic member 420 is in contact with the surface 217 of the housing portion 218. The surface 217 faces the solenoid portion 100 and is not in contact with the spool 220. The elastic member 420 is in contact with the end surface 56 of the magnetic attraction core 50 adjacent to the valve portion 200. Therefore, in the configuration in which the elastic member 420 is brought into contact with the end surface 56 of the stator core 40 to urge the stator core 40 toward the bottom 14, the sliding of the spool 220 is not hindered by the elastic member 420, and the outer diameter of the spool 220 can be made larger than the outer diameter of the end portion 54 of the stator core 40. Therefore, the outer diameter of the spool can be increased without enlarging the entire solenoid valve 300 in the radial direction, that is, while maintaining the physique of the solenoid valve 300.

Further, according to this embodiment, since the stator core 40 is urged toward the bottom 14 by the elastic member 420, the magnetic flux transfer portion 65 can be pressed against the bottom 14. Therefore, the loss of the magnetic flux transmitted from the bottom 14 of the yoke 10 to the magnetic flux transfer portion 65 can be suppressed.

According to the solenoid portion 100, the sliding core 60 has the tubular core portion 61 arranged radially outside the plunger 30 and the magnetic flux transfer portion 65 formed outward in the radial direction from the core end 62 of the core portion 61 to transfer the magnetic flux. Therefore, there is no gap between the core portion 61 and the magnetic flux transfer portion 65 in the radial direction. Therefore, it is possible to suppress the occurrence of radial bias in the distribution of the magnetic flux transmitted from the magnetic flux transfer portion 65 to the plunger 30 via the core portion 61. Therefore, it is possible to suppress the generation of side force due to the bias of the magnetic flux distribution.

Further, according to this embodiment, the stator core 40 is not provided with a flange portion protruding outward in the radial direction, at a location adjacent to the valve portion 200. The elastic member 420 is brought into contact with the end surface 56 of the stator core 40. The outer diameter of the spool 220 can be made larger than the outer diameter of the end portion 54 of the stator core 40 while urging the yoke 10 toward the bottom 14.

Further, instead of the flange portion of the stator core 40 adjacent to the valve portion 200, the ring member 19 provided on the radially outer side of the magnetic attraction core 50 of the stator core 40 is located between the magnetic attraction core 50 and the side wall 12 of the yoke 10, to transfer the magnetic flux. Further, since the ring member 19 is configured to be displaceable in the radial direction, it is possible to absorb the dimensional variation in manufacturing of the stator core 40 and the axial deviation in assembly.

### Second Embodiment

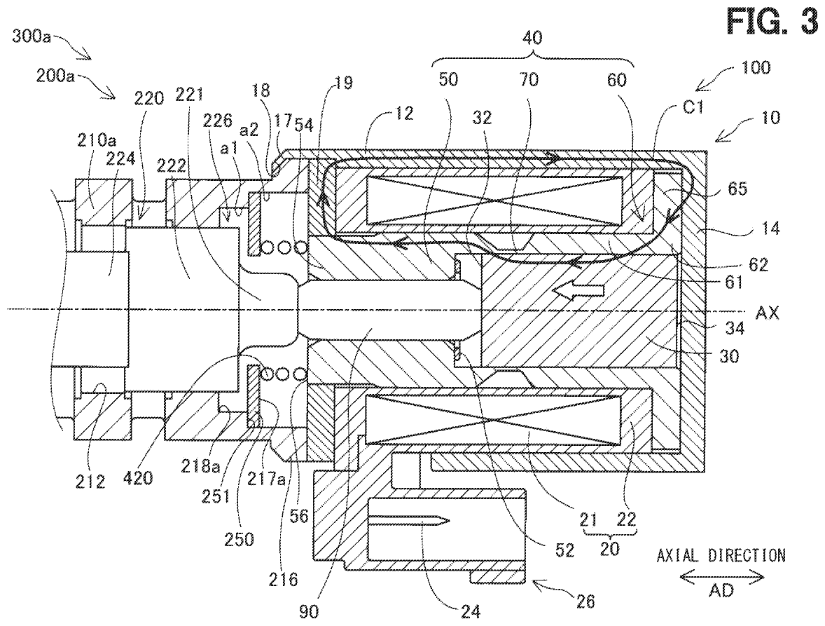

FIG. 3 corresponds to FIG. 2 of the first embodiment. In the following embodiments, the same configurations are designated by the same reference numerals, and detailed description thereof will be omitted. In the solenoid valve 300a of the second embodiment shown in FIG. 3, the housing portion 218a of the sleeve 210a of the valve portion 200a has a first inner diameter portion a1 having a first inner diameter and a second inner diameter portion a2 having an inner diameter larger than that of the first inner diameter portion a1. The second inner diameter portion a2 is located between the first inner diameter portion a1 and the solenoid portion 100 in the axial direction AD. The first inner diameter portion a1 and the second inner diameter portion a2 are connected by a connection surface 251 parallel to the radial direction. In this embodiment, it can be said that a step is provided in the housing portion 218b. The connection surface 251 is formed on the radially outer side of the small diameter portion 221 of the spool end portion 226. A ring plate 250, which is a substantially ring-shaped plate-shaped member, is in contact with the connection surface 251. In the present embodiment, the ring plate 250 is a member constituting the housing portion 218a. The ring plate 250 is, for example, press-fitted into the insertion hole 212 of the sleeve 210a from a side of the solenoid portion 100, and is arranged so as to abut on the connection surface 251. The ring plate 250 is arranged radially outside the small diameter portion 221 of the spool end portion 226. Therefore, the ring plate 250 is not in contact with the spool 220. The elastic member 420 is arranged in contact with the surface 217a of the ring plate 250 facing the solenoid portion 100 and the end surface 56 of the magnetic attraction core 50 adjacent to the valve portion 200a. Other configurations of the solenoid valve 300a of the second embodiment are the same as those of the solenoid valve 300 of the first embodiment. The solenoid valve 300a of the second embodiment also has the same effect as that of the first embodiment.

### Third Embodiment

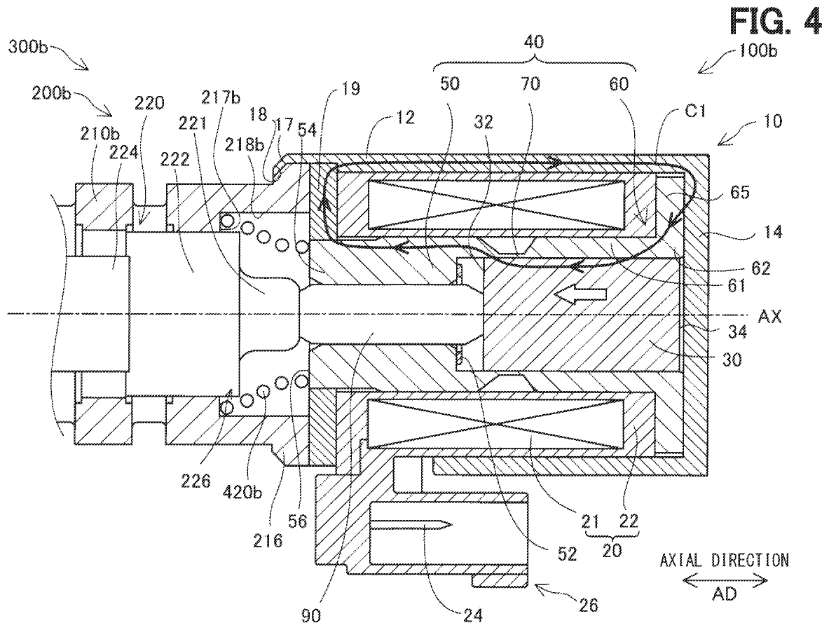

FIG. 4 corresponds to FIG. 2 of the first embodiment. In the solenoid valve 300b of the third embodiment, the housing portion 218b of the valve portion 200b does not include the flange 219 or the ring plate 250 as in the above-described embodiment. In the present embodiment, as shown in FIG. 4, the inner diameter of the housing portion 218b is substantially constant in the axial direction AD. The shape of the elastic member 420b in the third embodiment is a tapered shape in which the inner diameter and the outer diameter are monotonically increased from the solenoid portion 100b to the valve portion 200b in the axial direction AD. The elastic member 420b is arranged in contact with the surface 217b of the housing portion 218b and the end surface 56 of the magnetic attraction core 50 adjacent to the valve portion 200b. The surface 217b is connected to the insertion hole 212 of the sleeve 210b and faces the solenoid portion 100b. The surface 217b is not in contact with the spool 220. Other configurations of the solenoid valve 300b of the third embodiment are the same as those of the solenoid valve 300 of the first embodiment. The solenoid valve 300b of the third embodiment also has the same effect as that of the first embodiment.

### Other Embodiment

(1) The configuration of the solenoid portion 100, 100b in each of the embodiments is an example and can be changed in various ways. For example, the core portion 61 of the sliding core 60 and the magnetic flux transfer portion 65 may be formed separately from each other. In such a configuration, the core portion 61 may be press-fitted into the inner hole of the magnetic flux transfer portion 65 formed in an annular shape. Further, for example, the elastic member 420, 420b is not limited to the compression coil spring, and may be composed of any elastic member such as disc spring and leaf spring. Such a configuration also achieves the same effects as those of the embodiment described above.

(2) The spool end portion 226 of each of the embodiments is located in the housing portion 218, 218a, 218b when the movement of the spool 220 toward the solenoid portion 100 is restricted. The outer diameter of the spool end portion in the radial direction orthogonal to the axial direction AD may be monotonically increased from the solenoid portion 100, 100b toward the valve portion 200, 200a, 200b, and is not limited to the shape of each embodiment. For example, the spool end portion 226 may have a shape in which the outer diameter gradually increases as the position in the axial direction AX moves toward the valve portion 200, 200a, 200b.

(3) The solenoid valve 300, 300a, 300b of each of the embodiments is applied to a linear solenoid valve for controlling the hydraulic pressure of hydraulic oil supplied to an automatic transmission for a vehicle, but is not limited thereto. For example, the solenoid valve is not limited to being mounted on the valve body provided on the outer surface of the transmission case, but may be mounted on any hydraulic device that requires control of hydraulic pressure.

The present disclosure should not be limited to the embodiments described above, and various other embodiments may be implemented without departing from the scope of the present disclosure. For example, the technical features in each embodiment may be used to solve some or all of the above-described problems, or to provide one of the above-described effects. In order to achieve a part or all, replacement or combination can be appropriately performed. Also, if the technical features are not described as essential in the present specification, they can be deleted as appropriate.

What is claimed is:

1. A solenoid valve comprising:
a solenoid portion having a coil that generates a magnetic force when being energized; and
a valve portion having a sleeve extending in an axial direction, the sleeve having an insertion hole formed along a central axis and a housing portion larger than an end portion of the insertion hole adjacent to the solenoid portion in a radial direction, wherein
the valve portion has a spool arranged in the insertion hole to slide in the axial direction, the spool having a spool end portion that is an end portion of the spool adjacent to the solenoid portion, the spool end portion being located in the housing portion when a movement of the spool is restricted toward the solenoid portion, an outer diameter of the spool end portion in the radial direction orthogonal to the axial direction is monotonically increased from the solenoid portion toward the valve portion,
the solenoid portion has a magnetic yoke housing the coil, the magnetic yoke having a side wall extended in the axial direction and a bottom formed to extend in a direction intersecting the axial direction,
the solenoid portion has a plunger that slides in the axial direction,
the solenoid portion has a stator core including a magnetic attraction core arranged to face a distal end surface of the plunger in the axial direction and configured to attract magnetically the plunger by the magnetic force generated by the coil,
the stator core has a sliding core including: a core portion arranged inside the coil in the radial direction and housing the plunger; and a first magnetic flux transfer portion formed radially outward from a core end which is an end portion of the core portion in the axial direction and faces the bottom so as to transfer magnetic flux between the yoke and the core portion,
the stator core has a magnetic flux passage suppresser configured to suppress passage of magnetic flux between the sliding core and the magnetic attraction core,
the solenoid portion has a shaft provided between the plunger and the spool in the axial direction, the shaft being arranged inside the magnetic attraction core in the radial direction so as to transmit a thrust of the solenoid portion to the spool, and
an elastic member is arranged in the housing portion to urge the stator core toward the bottom at a radially outer side of an outer peripheral surface of the spool end portion, the elastic member being in contact with a surface of the housing portion which is non-contact with the spool when the spool slides toward the solenoid portion, the elastic member being in contact with an end surface of the magnetic attraction core adjacent to the valve portion.

2. The solenoid valve according to claim 1, wherein
the housing portion has a flange protruding inward in the radial direction, and
the elastic member is arranged in contact with a surface of the flange facing the solenoid portion and the end surface of the magnetic attraction core adjacent to the valve portion.

3. The solenoid valve according to claim 1, wherein
the housing portion has
a first inner diameter portion,
a second inner diameter portion having an inner diameter larger than that of the first inner diameter portion, the second inner diameter portion being located between the first inner diameter portion and the solenoid portion,
a connection surface connecting the first inner diameter portion and the second inner diameter portion to each other in the radial direction, and
a ring plate in contact with the connection surface, the ring plate being located at a radially outer side of an outer peripheral surface of the spool end portion, and
the elastic member is arranged in contact with a surface of the ring plate facing the solenoid portion and the end surface of the magnetic attraction core adjacent to the valve portion.

4. The solenoid valve according to claim 1, wherein
the elastic member has a tapered shape in which an inner diameter and an outer diameter of the elastic member are monotonically increased from the solenoid portion to the valve portion.

5. The solenoid valve according to claim 1, wherein
the spool end portion has a first outer diameter portion and a second outer diameter portion having an outer diameter larger than that of the first outer diameter portion,
the second outer diameter portion is connected to the first outer diameter portion and is located between the valve portion and the first outer diameter portion, and
the outer diameter of the first outer diameter portion is smaller than an outer diameter of the magnetic attraction core, and the outer diameter of the second outer diameter portion is larger than the outer diameter of the magnetic attraction core.

6. The solenoid valve according to claim 1, wherein
the solenoid portion has a second magnetic flux transfer portion arranged at a radially outer side of an end portion of the magnetic attraction core adjacent to the valve portion, so as to transfer magnetic flux between the magnetic attraction core and the side wall.
